(19) United States
(12) Patent Application Publication
(10) Pub. No.: US 2008/0205458 A1
(43) Pub. Date: Aug. 28, 2008

(54) LASER BEAM IRRADIATION APPARATUS AND LASER BEAM MACHINING APPARATUS

(75) Inventors: Yutaka Kobayashi, Ota-ku (JP); Kouichi Nehashi, Ota-ku (JP); Keiji Nomaru, Ota-ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/028,395

(22) Filed: Feb. 8, 2008

(30) Foreign Application Priority Data
Feb. 26, 2007 (JP) 2007-45933

(51) Int. Cl. H01S 3/10

(52) U.S. Cl. 372/25

(57) ABSTRACT

A laser beam irradiation apparatus including: a laser beam oscillation unit having a pulsed laser beam oscillator for oscillating a pulsed laser beam, and a repetition frequency setter; an acousto-optical deflector by which the pulsed laser beam oscillated by the laser beam oscillation unit is deflected and the output is adjusted; and a controller for controlling the acousto-optical deflector. The controller outputs to the acousto-optical deflector a driving pulse signal having a predetermined time width including the pulse width of the pulsed laser beam oscillated by the pulsed laser beam oscillator, based on a repetition frequency setting signal from the repetition frequency setter, and outputs a correction pulse signal to the acousto-optical deflector between the driving pulses.

### BACKGROUND OF THE INVENTION

1. Field of the Invention

The present invention relates to laser beam irradiation apparatus for irradiating a work with a laser beam, and a laser beam machining apparatus including the laser beam irradiation apparatus.

2. Description of the Related Art

In a semiconductor device manufacturing process, a plurality of regions are demarcated in a surface of a substantially circular disk-like semiconductor wafer by planned dividing lines called streets which are arranged in a lattice pattern, and devices such as ICs and LSIs are formed in the demarcated regions. Then, the semiconductor wafer is cut (diced) along the planned dividing lines to divide the regions with the devices formed therein, whereby individual semiconductor chips are manufactured.

In order to realize a smaller device size and higher functions, a module structure has been put to practical use in which a plurality of semiconductor chips are stacked and electrodes of the stacked semiconductor chips are connected. The module structure has a configuration in which via holes are formed in areas, where the electrodes are formed, of the semiconductor wafer, and the via holes are filled with a conductive material such as aluminum to be connected to the electrodes (refer to, for example, Japanese Patent Laid-open No. 2003-163323). The via holes provided in the semiconductor wafer are formed by use of a drill. However, the via holes provided in the semiconductor wafer have a diameter as small as 90 to 300 μm, and productivity is low if the via holes are formed by drilling.

On the other hand, a laser beam machining apparatus by which small-diameter holes can be efficiently formed in a work such as a semiconductor wafer is disclosed in Japanese Patent Laid-open No. 2006-247674. The laser beam machining apparatus includes machining feed amount detection means for detecting the relative machining feed amount of a chuck table holding the work and laser beam irradiation means, storage means for storing the X and Y coordinates of each via hole to be formed in the work, and control means for controlling the laser beam irradiation means on the basis of the X and Y coordinates of the small-diameter hole stored in the storage means and the detection signal from the machining feed amount detection means, wherein the work is irradiated with one pulse of laser beam when the X and Y coordinates of the small-diameter hole to be formed in the work have reached a position just under a condenser of the laser beam irradiation means.

However, there is a problem as follows. In order to form a via hole in a work, the same portion of the work has to be irradiated with a pulsed laser beam a plurality of times. When the above-mentioned laser beam machining apparatus is used, therefore, the movement of the work has to be carried out a plurality of times, which may not necessarily be satisfactory from the viewpoint of productivity. In order to solve this problem, the present applicant has proposed as Japanese Patent Application No. 2005-362236 a laser beam machining apparatus including laser beam irradiation means having acousto-optical deflection means using an acousto-optical device, wherein a laser beam oscillated by laser beam oscillation means is deflected when passing through the acousto-optical device, whereby the same machining position of the work is irradiated with the laser beam while machining feed of the work is being conducted.

The acousto-optical deflection means includes the acousto-optical device for deflecting the laser beam oscillated by the laser beam oscillation means, an RF oscillator for applying RF (radio frequency) to the acousto-optical device, deflection angle adjusting means for adjusting the frequency of the RF outputted from the RF oscillator, and output adjusting means for adjusting the amplitude of the RF generated by the RF oscillator. The acousto-optical deflection means has the problem that, when application of the RF to the acousto-optical device is continued, a thermal strain would be produced in the acousto-optical, generating an error in the deflection angle of the laser beam, or the output of the laser beam would become uneven, making it impossible to achieve accurate machining. Besides, unless the temperature of the acousto-optical device is maintained in a predetermined range, an error may be generated in the deflection angle of the laser beam, or the output of the laser beam may become uneven, making it impossible to achieve high-accuracy machining.

### SUMMARY OF THE INVENTION

Accordingly, it is an object of the present invention to provide a laser beam irradiation apparatus and a laser beam machining apparatus by which high-accuracy machining can be performed by maintaining the temperature of an acousto-optical device constituting acousto-optical deflection means in a predetermined range.

In accordance with an aspect of the present invention, there is provided a laser beam irradiation apparatus including: laser beam oscillation means including a pulsed laser beam oscillator for oscillating a pulsed laser beam, and repetition frequency setting means for setting a repetition frequency of the pulsed laser beam oscillated from the pulsed laser beam oscillator; acousto-optical deflection means including an acousto-optical device for deflecting the pulsed laser beam oscillated from the laser beam oscillation means, an RF oscillator for applying RF to the acousto-optical device, deflection angle adjusting means for adjusting the frequency of the RF outputted from the RF oscillator, and output adjusting means for adjusting the amplitude of the RF outputted from the RF oscillator; control means for controlling the acousto-optical deflection means and the output adjusting means; and a condenser for condensing the laser beam deflected by the acousto-optical deflection means, wherein the control means, based on a repetition frequency setting signal from the repetition frequency setting means, outputs to the deflection angle adjusting means a first driving pulse signal with a predetermined time width containing the pulse width of the pulsed laser beam oscillated by the pulsed laser beam oscillator, outputs a second driving pulse signal to the output adjusting means, and outputs to the RF oscillator a correction pulse signal between the driving pulses composed of the first driving pulse signal and the second driving pulse signal.

The control means outputs the correction pulse signal to the deflection angle adjusting means or the output adjusting means. In addition, the acousto-optical deflection means includes an RF output correction means for adjusting the RF output produced by the RF oscillator, and the control means outputs the correction pulse signal to the RF output correction means. The control means preferably has a control map setting the voltages of the first driving pulse signal and the second driving pulse signal and the correction pulse signal.

In accordance with another aspect of the present invention, there is provided a laser beam machining apparatus including a chuck table for holding a work, laser beam irradiation means for irradiating the work held by the chuck table with a laser beam, machining feeding means for relatively moving the chuck table and the laser beam irradiation means in a machining feed direction (X-axis direction), and indexing means for relatively moving the chuck table and the laser beam irradiation means in an indexing direction (Y-axis direction) orthogonal to the machining feed direction (X-axis direction), wherein the laser beam irradiation means includes the above-mentioned laser beam irradiation apparatus.

According to the laser beam irradiation apparatus based on the present invention, the first driving pulse signal with a predetermined time width containing the pulse width of the pulsed laser beam oscillated by the pulsed laser beam oscillator is outputted to the deflection angle adjusting means, and the second driving pulse signal is outputted to the output adjusting means. Therefore, the time for which the RF is applied to the first acousto-optical device and the second acousto-optical device is extremely short as compared with the period of the pulsed laser beam oscillated from the pulsed laser beam oscillator, so that the thermal strain generated in the acousto-optical devices is suppressed. Thus, according to the laser beam irradiation apparatus based on the present invention, the above-mentioned trouble arising from the thermal strain in the acousto-optical devices can be obviated, and high-accuracy machining can be achieved.

Furthermore, since the correction pulse signal is outputted to the RF oscillator between the driving pulses composed of the first driving pulse signal and the second driving pulse signal, corrected RF is applied to the first acousto-optical device and the second acousto-optical device even between the pulses when the pulsed laser beam is oscillated, so that variations in the temperatures of the first acousto-optical device and the second acousto-optical device are suppressed. Accordingly, the functions of the first acousto-optical device and the second acousto-optical device can be maintained accurately.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser beam machining apparatus configured according to the present invention;

FIG. 2 is a block diagram of a laser beam irradiation apparatus with which the laser beam machining apparatus shown in FIG. 1 is equipped;

FIG. 3 illustrates the relationship between a pulsed laser beam oscillated from pulsed laser beam oscillation means in the laser beam irradiation apparatus shown in FIG. 2 and a driving pulse signal of voltage which is applied to acousto-optical deflection means;

FIG. 4 is a plan view of a semiconductor wafer as a work;

FIG. 5 is a plan view showing, in an enlarged state, a part of the semiconductor wafer shown in FIG. 4;

FIG. 6 is a perspective view showing the condition where the semiconductor wafer shown in FIG. 4 is adhered to a surface of a protective tape attached to an annular frame;

FIG. 7 illustrates the relationship between the semiconductor wafer shown in FIG. 4 and the coordinates of the semiconductor wafer in the state of being held at a predetermined position of a chuck table in the laser beam machining apparatus shown in FIG. 1;

FIGS. 8A and 8B illustrate a boring step carried out by the laser beam machining apparatus shown in FIG. 1;

FIGS. 9A and 9B illustrate, in an enlarged form, the details of the boring step shown in FIGS. 8A and 8B;

FIG. 10 illustrates the details of the boring step in an enlarged form;

FIG. 11 illustrates a part of a control map stored in a memory of control means constituting the laser beam machining apparatus shown in FIG. 2;

FIGS. 12A and 12B illustrate the boring step carried out by the laser beam machining apparatus shown in FIG. 1;

FIG. 13 illustrates another embodiment of the control map stored in the memory of the control means constituting the laser beam irradiation apparatus shown in FIG. 2; and

FIG. 14 illustrates a further embodiment of the control map stored in the memory of the control means constituting the laser beam irradiation apparatus shown in FIG. 2.

### DETAILED DESCRIPTION OF THE PREFERRED EMBODIMENTS

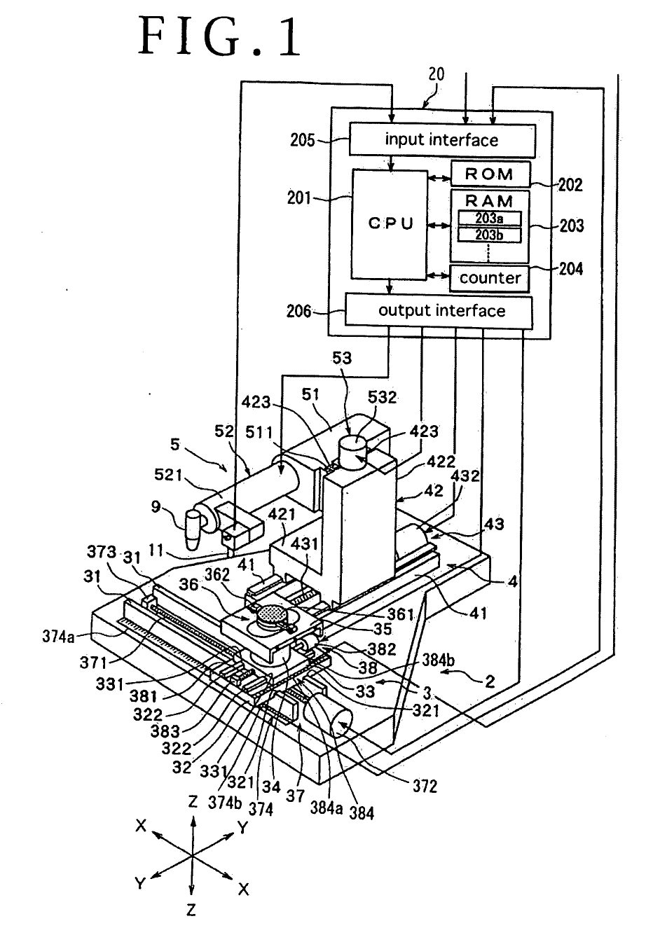

Now, preferred embodiments of the laser beam irradiation apparatus and the laser beam machining apparatus which are configured according to the present invention will be described more in detail below, referring to the attached drawings. FIG. 1 shows a perspective view of the laser beam machining apparatus configured according to the present invention. The laser beam machining apparatus shown in FIG. 1 includes a stationary base 2, a chuck table mechanism 3 which is disposed on the stationary base 2 so as to be movable in a machining feed direction by arrow X (X-axis direction) and which holds a work, a laser beam irradiation unit support mechanism 4 disposed on the stationary base 2 so as to be movable in an indexing direction indicated by arrow Y (Y-axis direction) which is orthogonal to the direction indicated by arrow X (X-axis direction), and a laser beam irradiation unit 5 disposed on the laser beam unit support mechanism 4 so as to be movable in a direction indicated by arrow Z (Z-axis direction).

The chuck table mechanism 3 includes a pair of guide rails 31, 31 disposed on the stationary base 2 in parallel to each other along the machining feed direction indicated by arrow X (X-axis direction), a first sliding block 32 disposed on the guide rails 31, 31 so as to be movable in the machining feed direction indicated by arrow X (X-axis direction), a second sliding block 33 disposed on the first sliding block 32 so as to be movable in the indexing direction indicated by arrow Y (Y-axis direction), a cover table 35 supported over the second sliding block 33 by a hollow cylindrical member 34, and a chuck table 36 as work holding means. The chuck table 36 has a suction chuck 361 formed from a porous material so that the work, for example, a circular disk-like semiconductor wafer is held on the suction chuck 361 by suction means (not shown). The chuck table 36 configured in this manner is rotated by a pulse motor (not shown) disposed inside the hollow cylindrical member 34. Incidentally, the chuck table 36 is equipped with clamps 362 for fixing an annular frame which will be described later.

The first sliding block 32 is provided in its lower surface with a pair of guided grooves 321, 321 for engagement with the pair of guide rails 31, 31, and is provided on its upper surface with a pair of guide rails 322, 322 formed in parallel to each other along the indexing direction indicated by arrow Y (Y-axis direction). The first sliding block 32 thus configured can be moved in the machining feed direction indicated by arrow X (X-axis direction) along the pair of guide rails 31, 31, with its guided grooves 321, 321 in engagement with the pair of guide rails 31, 31. The chuck table mechanism 3 in the embodiment shown in the figure has machining feeding means 37 by which the first sliding block 32 is moved in the machining feed direction indicated by arrow X (X-axis direction) along the pair of guide rails 31, 31.

The machining feeding means 37 includes a male screw rod 371 disposed between and in parallel to the pair of guide rails 31 and 31, and a drive source such as a pulse motor 372 for rotationally driving the male screw rod 371. The male screw rod 371 is rotatably supported at its one end on a bearing block 373 fixed to the stationary base 2, and is power-transmittingly connected at its other end to an output shaft of the pulse motor 372. Incidentally, the male screw rod 371 is in screw engagement with a penetrating female screw hole formed in a female screw block (not shown) projectingly provided at a lower surface of a central part of the first sliding block 32. Therefore, with the male screw rod 371 driven by the pulse motor 372 to rotate normally and reversely, the first sliding block 32 is moved in the machining feed direction indicated by arrow X (X-axis direction) along the guide rails 31, 31.

The laser beam machining apparatus in the embodiment shown in the figure has machining feed amount detection means 374 for detecting the machining feed amount of the chuck table 36. The machining feed amount detection means 374 is composed of a linear scale 374a disposed along the guide rail 31, and a reading head 374b which is disposed on the first sliding block 32 and which is moved along the linear scale 374a together with the first sliding block 32. In the embodiment shown in the figure, the reading head 374b of the feed amount detection means 374 sends to control means (described later) a pulse signal which contains one pulse per 1-μm feed. Then, the control means (described later) counts the pulses in the pulse signal inputted thereto, to thereby detects the machining feed amount of the chuck table 36.

Incidentally, in the case where the pulse motor 372 is used as the drive source of the machining feeding means 37, the machining feed amount of the chuck table 36 can be detected also by counting the driving pulses in the control means (described later) which outputs a driving signal to the pulse motor 372. Besides, in the case where a servo motor is used as the drive source of the machining feeding means 37, the machining feed amount of the chuck table 36 can be detected also by a method in which a pulse signal outputted from a rotary encoder for detecting the number of revolutions of the servo motor is sent to the control means (described later), and the control means counts the pulses contained in the pulse signal inputted thereto.

The second sliding block 33 is provided in its lower surface with a pair of guided grooves 331, 331 for engagement with the pair of guide rails 322, 322 provided on the upper surface of the first sliding block 32, and can be moved in the indexing direction indicated by arror Y (Y-axis direction), with the guided grooves 331, 331 in engagement with the pair of guide rails 322, 322. The chuck table mechanism 3 in the embodiment shown in the figure has first indexing feeding means 38 by which the second sliding block 33 is moved in the indexing direction indicated by arrow Y (Y-axis direction) along the pair of guide rails 322, 322 provided on the first sliding block 32.

The first indexing feeding means 38 includes a male screw rod 371 disposed between and in parallel to the pair of guide rails 322 and 322, and a drive source such as a pulse motor 372 for rotationally driving the male screw rod 371. The male screw rod 371 is rotatably supported at its one end on a bearing block 383 fixed to the upper surface of the first sliding block 32, and is power-transmittingly connected at its other end to an output shaft of the pulse motor 372. Incidentally, the male screw rod 371 is in screw engagement with a penetrating female screw hole formed in a female screw block (not shown) projectingly provided at a lower surface of a central part of the second sliding block 33. Therefore, with the male screw rod 371 driven by the pulse motor 372 to rotate normally and reversely, the second sliding block 33 is moved in the indexing direction indicated by arrow Y (Y-axis direction) along the guide rails 322, 322.

The laser beam machining apparatus in the embodiment shown in the figure has indexing feed amount detection means 384 for detecting the indexing feed amount of the second sliding block 33. The indexing feed amount detection means 384 is composed of a linear scale 384a disposed along the guide rail 322, and a reading head 384b which is disposed on the second sliding block 33 and which is moved along the linear scale 384a together with the second sliding block 33. In the embodiment shown in the figure, the reading head 384b of the feed amount detection means 384 sends to the control means (described later) a pulse signal containing one pulse per 1-μm feed. Then, the control means (described later), counts the pulses contained in the pulse signal inputted thereto, to thereby detect the indexing feed amount of the chuck table 36. Incidentally, in the case where the pulse motor 372 is used as the drive source of the indexing feeding means 38, the indexing feed amount of the chuck table 36 can be detected also by counting the driving pulses in the control means (described later) which outputs a driving signal to the pulse motor 372. Besides, in the case where a servo motor is used as the drive source of the first indexing feeding means 38, the indexing feed amount of the chuck table 36 can be detected also by a method in which a pulse signal outputted from a rotary encoder for detecting the number of revolutions of the servo motor is sent to the control means (described later), and the control means counts the pulses contained in the pulse signal inputted thereto.

The laser beam irradiation unit support mechanism 4 has a pair of guide rails 41, 41 disposed on the stationary base 2 in parallel to each other along the indexing direction indicated by arrow Y (Y-axis direction), and a movable support base 42 disposed on the guide rails 41, 41 so as to be movable in the direction indicated by arrow Y. The movable support base 42 is composed of a moving support part 421 movably disposed on the guide rails 41, 41, and an attachment part 422 attached to the moving support part 421. The attachment part 422 is provided on its one side surface with a pair of guide rails 423, 423 extending in the direction indicated by arrow Z (Z-axis direction). The laser beam irradiation unit support mechanism 4 in the embodiment shown in the figure has second indexing feeding means 43 by which the movable support base 42 is moved in the indexing direction indicated by arrow Y (Y-axis direction) along the pair of guide rails 41, 41.

The second indexing feeding means 43 includes a male screw rod 431 disposed between and in parallel to the pair of guide rails 41 and 41, and a drive source such as a pulse motor 432 for rotationally driving the male screw rod 431. The male screw rod 431 is rotatably supported at its one end on a bearing block (not shown) fixed to the stationary base 2, and is power-transmittingly connected at its other end to an output shaft of the pulse motor 432. Incidentally, the male screw rod 431 is in screw engagement with a female screw hole formed in a female screw block (not shown) projectingly provided at a lower surface of a central part of the moving support part 421 constituting the movable support base 42. Therefore, with the male screw rod 431 driven by the pulse motor 432 to rotate normally and reversely, the movable support base 42 is moved in the indexing direction indicated by arrow Y (Y-axis direction) along the guide rails 41, 41.

The laser beam irradiation unit 5 in the embodiment shown in the figure has a unit holder 51, and a laser beam irradiation apparatus 52 attached to the unit holder 51. The unit holder 51 is provided with a pair of guided grooves 511, 511 for slidable engagement with the pair of guide rails 423, 423 provided on the attachment part 422, and is supported so as to be movable in the direction indicated by arrow Z (Z-axis direction), with its guided grooves 511, 511 in engagement with the guide rails 423, 423.

The laser beam irradiation unit 5 in the embodiment shown in the figure has moving means 53 for moving the unit holder 51 in the direction indicated by arrow Z (Z-axis direction) along the pair of guide rails 423, 423. The moving means 53 includes a male screw rod (not shown) disposed between the pair of guide rails 423 and 423, and a drive source such as a pulse motor 532 for rotationally driving the male screw rod. With the male screw rod (not shown) driven by the pulse motor 532 to rotate normally and reversely, the unit holder 51 and the laser beam irradiation means 52 are moved in the direction indicated by arrow Z (Z-axis direction) along the guide rails 423, 423. Incidentally, in the embodiment shown in the figure, the laser beam irradiation apparatus 52 is moved upward when the pulse motor 532 is driven to rotate normally, and the laser beam irradiation apparatus 52 is moved downward when the pulse motor 532 is driven to rotate reversely.

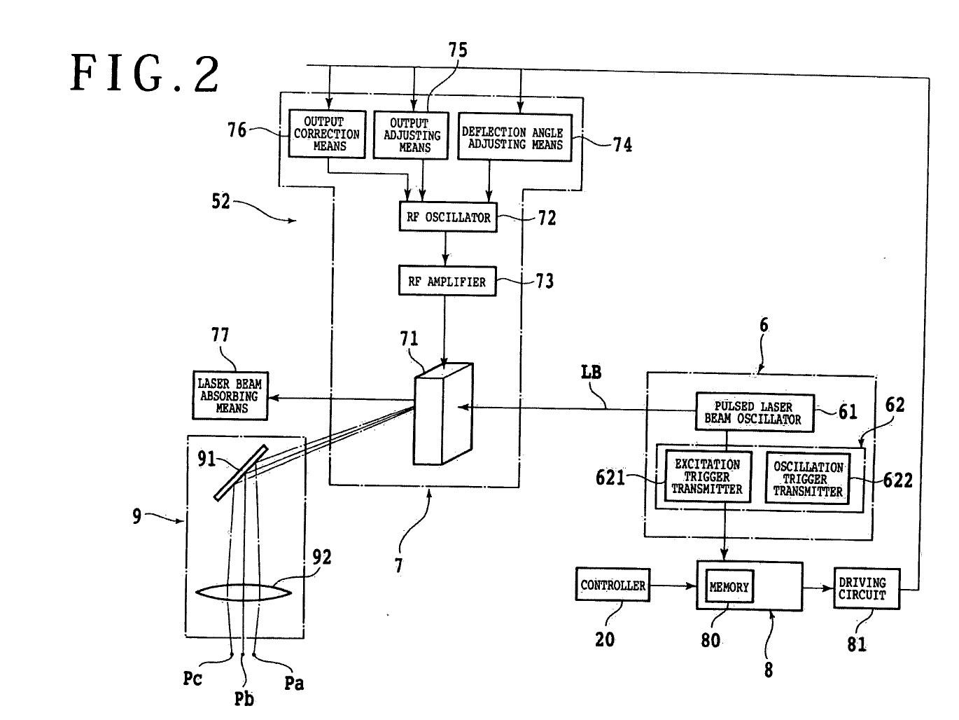

The laser beam irradiation apparatus 52 includes a hollow cylindrical casing 521 disposed substantially horizontally, pulsed laser beam oscillation means 6 disposed inside the casing 521 as shown in FIG. 2, acousto-optical deflection means 7 by which the laser beam oscillated by the pulsed laser beam oscillation means 6 is deflected in the machining feed direction (X-axis direction), and control means 8 for controlling the acousto-optical deflection means 7. Besides, the laser beam irradiation means 52 has a condenser 9 by which the pulsed laser beam having passed through the acousto-optical deflection means 7 is made to irradiate the work held on the chuck table 36 therewith.

The pulsed laser beam oscillation means 6 is composed of a pulsed laser beam oscillator 61 composed of a YAG laser oscillator or a YVO4 laser oscillator, and repetition frequency setting means 62 annexed thereto. The pulsed laser beam oscillator 61 oscillates a pulsed laser beam LB at a predetermined frequency set by the repetition frequency setting means 62. The repetition frequency setting means 62 has an excitation trigger transmitter 621 and an oscillation trigger transmitter 622. In the pulsed laser beam oscillation means 6 thus configured, the pulsed laser beam oscillator 61 starts excitation based on an excitation trigger outputted from the excitation trigger transmitter 621 on the basis of a predetermined period, and the pulsed laser beam oscillator 61 oscillates a pulsed laser beam based on the oscillation trigger outputted from the oscillation trigger transmitter 622 on the basis of a predetermined period.

The acousto-optical deflection means 7 includes an acousto-optical device 71 by which the laser beam oscillated by the laser beam oscillation means 6 is deflected in the machining feed direction (X-axis direction), an RF oscillator 72 for producing RF (radio frequency) to be applied to the acousto-optical device 71, an RF amplifier 73 by which the power of the RF produced by the RF oscillator 72 is amplified before the RF is applied to the acousto-optical device 71, deflection angle adjusting means 74 for adjusting the frequency of the RF produced by the RF oscillator 72, output adjusting means 75 for adjusting the amplitude of the RF produced by the RF oscillator 72, and RF output correction means 76 for adjusting the RF output produced by the RF oscillator 72. The acousto-optical device 71 ensures that the angle of deflection of the laser beam can be adjusted correspondingly to the frequency of the RF applied and that the output of the laser beam can be adjusted correspondingly to the amplitude of the RF applied. Incidentally, the deflection angle adjusting means 74, the output adjusting means 75 and the RF output correction means 76 are controlled by the control means 8. In addition, the laser beam irradiation apparatus 52 in the embodiment shown in the figure has laser beam absorbing means 77 for absorbing the laser beam deflected by the acousto-optical device 71 as indicated by broken line in FIG. 2 in the case where RF at a predetermined frequency is applied to the acousto-optical device 71.

The control means 8 outputs to a driving circuit 81 a driving pulse signal corresponding to the pulses of the pulsed laser beam oscillated from the pulsed laser beam oscillator 61, based on an excitation trigger outputted from the excitation trigger transmitter 621 which is a repetition frequency setting signal from the repetition frequency setting means 62 of the pulsed laser beam oscillation means 6. Incidentally, the control means 8 has a memory 80 which stores a control map (described later) for setting the driving pulse signal to be outputted to the driving circuit 81. The driving circuit 81 applies voltages corresponding to the driving pulse signal from the control means 8, to the deflection angle adjusting means 74, the output adjusting means 75 and the RF output correction means 76 in the acousto-optical deflection means 7.

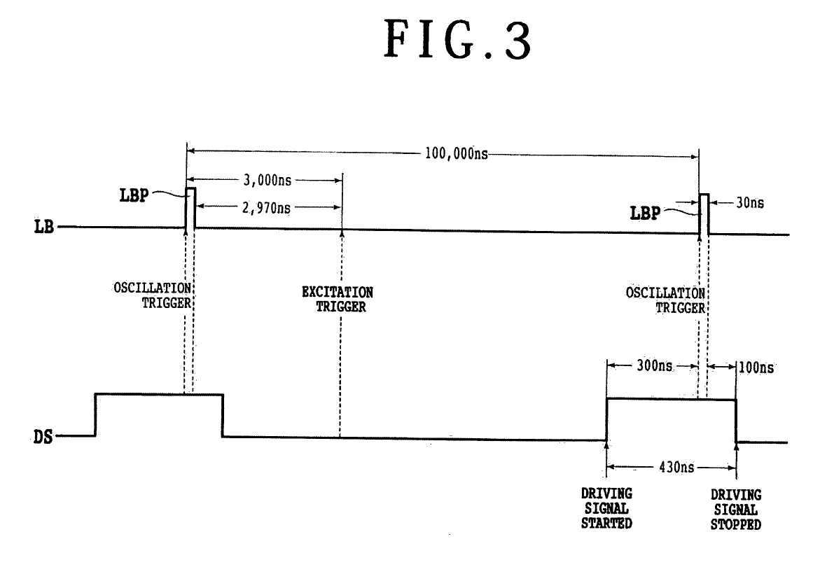

Here, the driving pulse signal outputted from the control means 8 to the driving circuit 81 will be described, referring to FIGS. 2 and 3. Incidentally, the frequency set by the repetition frequency setting means 62 of the pulsed laser beam oscillation means 6 is assumed to be 10 kHz, for example. It follows that the pulse LBP separation of the pulsed laser beam LB oscillated from the pulsed laser beam oscillator 61 is 100,000 ns, as shown in FIG. 3. In order to oscillate the pulsed laser beam LB shown in FIG. 3, the excitation trigger is outputted from the excitation trigger transmitter 621 to the pulsed laser beam oscillator 61 in the period after oscillation of one pulse and before oscillation of the next pulse. When the timing of the outputting of the excitation trigger is, for example, 3,000 ns after the outputting of the oscillation trigger from the oscillation trigger transmitter 622 to the pulsed laser beam oscillator 61, the pulse LBP width of the pulsed laser beam LB oscillated from the pulsed laser beam oscillator 61 is 30 ns, for example. Therefore, the excitation trigger is outputted 2,970 ns after one pulse of the pulsed laser beam LB is outputted from the pulsed laser beam oscillator 61. Under such a setting, the excitation trigger outputted from the excitation trigger transmitter 621 is sent also to the control means 8 which controls the deflection angle adjusting means 74 and the output adjusting means 75 in the acousto-optical deflection means 7.

The driving pulse signal (DS) for driving the deflection angle adjusting means 74 and the output adjusting means 75 in the acousto-optical deflection means 7 need to be outputted for a predetermined time including the pulse width of the pulses LBP of the pulsed laser beam LB oscillated from the pulsed laser beam oscillator 61. For example, where the time of starting the driving pulse signal (DS) is 300 ns before the outputting of the oscillation trigger and the time of ending the driving pulse signal (DS) is 100 ns after the end of the pulse LBP of the pulsed laser beam LB, the control means 8 starts outputting the driving pulse signal (DS) 96,700 ns after the oscillation of the excitation trigger, and outputs the driving pulse signal (DS) for 430 ns. The control means 8 outputs the driving pulse signal (DS) in this manner, whereby the deflection angle adjusting means 74 and the output adjusting means 75 in the acousto-optical deflection means 7 can be controlled over a period of 430 ns including the time for which the pulse LBP of the pulsed laser beam LB is being oscillated. Since the duration of the driving pulse signal (DS) is 430 ns and one period of the pulsed laser beam LB is 100,000 ns as above-mentioned, it suffices for the deflection angle adjusting means 74 and the output adjusting means 75 in the acousto-optical deflection means 7 to be driven for a time of 0.43% based on the irradiation time of the pulsed laser beam LB. Therefore, the time for which the RF is applied to the acousto-optical device 71 can be extremely short, as compared with the irradiation time of the pulsed laser beam LB, so that thermal strain generated in the acousto-optical device 71 can be suppressed.

Returning to FIG. 2 to continue description, the condenser 9 is attached to the tip of the casing 521, and includes a direction changing mirror 91 for changing the direction of the pulsed laser beam deflected by the acousto-optical deflection means 7 into the downward direction, and a condenser lens 92 for condensing the laser beam of which the direction has been changed by the direction changing mirror 91. The pulsed laser beam irradiation apparatus 52 in the embodiment shown in the figures is configured as above-mentioned, and its operation will be described below referring to FIG. 2.

In the case where a voltage of 5 V, for example, is applied from the driving circuit 81 to the deflection angle adjusting means 74 of the acousto-optical deflection means 7 and RF at a frequency corresponding to 5 V is applied to the acousto-optical device 71, the pulsed laser beam oscillated from the pulsed laser beam oscillation means 6 is deflected as indicated by dot-dash line in FIG. 2, and is condensed into a convergent point Pa. Besides, in the case where a voltage of 10 V, for example, is applied from the driving circuit 81 to the deflection angle adjusting means 74 and RF at a frequency corresponding to 10 V is applied to the acousto-optical device 71, the pulsed laser beam oscillated from the pulsed laser beam oscillation means 6 is deflected as indicated by solid line in FIG. 2, and is condensed into a convergent point Pb which is displaced from the convergent point Pa in the machining feed direction (X-axis direction), namely, leftwards in FIG. 2, by a predetermined amount.

On the other hand, in the case where a voltage of 15 V, for example, is applied from the driving circuit 81 to the deflection angle adjusting means 74 and RF at a frequency corresponding to 15 V is applied to the acousto-optical device 71, the pulsed laser beam oscillated from the pulsed laser beam oscillation means 6 is deflected as indicated by two-dot chain line in FIG. 2, and is condensed into a convergent point Pc which is displaced from the convergent point Pb in the machining feed direction (X-axis direction), namely, leftwards in FIG. 2, by a predetermined amount. Further, in the case where a voltage of 0 V, for example, is applied from the driving circuit 81 to the deflection angle adjusting means 74 of the acousto-optical deflection means 7 and RF at a frequency corresponding to 0 V is applied to the acousto-optical device 71, the pulsed laser beam oscillated from the pulsed laser beam oscillation means 6 is guided to the laser beam absorbing means 77 as indicated by broken line in FIG. 2. Thus, the laser beam deflected by the acousto-optical device 71 is deflected in the machining feed direction (X-axis direction) correspondingly to the voltage impressed on the deflection angle adjusting means 74.

Returning to FIG. 1 to continue description, the laser beam machining apparatus in the embodiment shown in the figure has image pickup means 11 which is disposed at a front end part of the casing 521 and which detects the work area to be laser beam machined by the laser beam irradiation apparatus 52. The image pickup means 11 includes not only an ordinary image pickup device (CCD) for picking up an image by use of visible rays but also infrared illumination means for irradiating the work with infrared rays, an optical system for capturing the infrared rays radiated by the infrared illumination means, an image pickup device (infrared CCD) for outputting an electrical signal corresponding to the infrared rays captured by the optical system, and the like, and sends to a controller (described later) a picture signal of the image picked up.

Continuing description based on FIG. 1, the laser beam machining apparatus in the embodiment shown in the figure has the controller 20. The controller 20 is composed of a computer, and includes a central processing unit (CPU) 201 for performing arithmetic operations according to a control program, a read only memory (ROM) 202 for storing the control program and the like, a random access memory (RAM) 203 capable of reading and writing and operative to store the control map (described later), design data on the work, results of arithmetic operations, etc., a counter 204, an input interface 205 and an output interface 206. Detection signals from the machining feed amount detection means 374, the indexing feed amount detection means 384, the image pickup means 11 and the like are inputted to the input interface 205 of the controller 20. Control signals are outputted from the output interface 206 of the controller 20 to the pulse motor 372, the pulse motor 382, the pulse motor 432, the pulse motor 532, the pulsed laser beam oscillation means 6, the control means 8 and the like. Incidentally, the random access memory (RAM) 203 has a second storage region 203a for storing the design data on the work (described later), and other storage region(s).

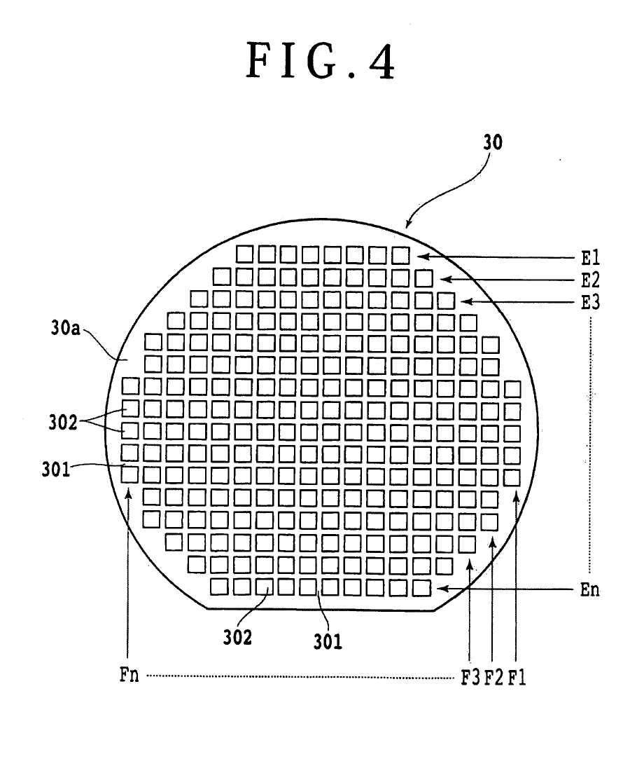

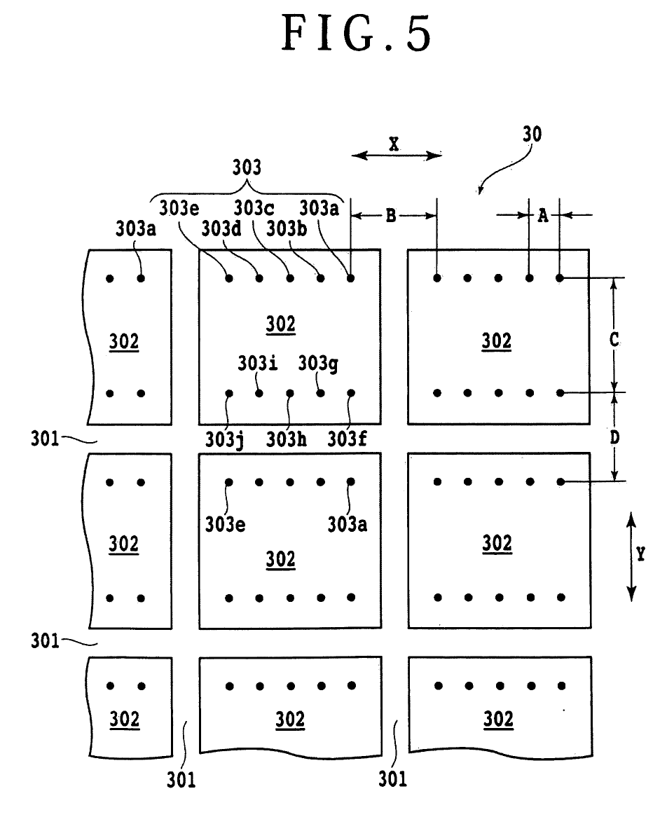

The laser beam machining apparatus in the embodiment shown in the figures is configured as above-mentioned, and its operation will be described below. FIG. 4 shows a plan view of a semiconductor wafer 30 as the work to be laser beam machined. The semiconductor wafer 30 shown in FIG. 4 is composed of a silicon wafer, a plurality of regions are demarcated in a surface (face side) 30a of the silicon wafer by a plurality of planned dividing lines 301 arranged in a lattice pattern, and devices 302 such as ICs and LSIs are formed in the demarcated regions. All the devices 302 have the same configuration. Each of the devices 302 is provided at its surface with a plurality of electrodes 303 (303a to 303j), as shown in FIG. 5. Incidentally, in the embodiment shown, the electrodes 303a and 303f, the electrodes 303b and 303g, the electrodes 303c and 303h, the electrodes 303d and 303i, and the electrodes 303e and 303j, are respectively the same in position in the X direction. In the areas of the plurality of electrodes 303 (303a to 303j), machined holes (via holes) reaching the electrodes 303 are formed from the back side 30b.

The interval A in the X direction (the left-right direction in FIG. 5) between the electrodes 303 (303a to 303j) on each device 302 and the interval B between the electrodes adjacent to each other in the X direction (the left-right direction in FIG. 5) with the planned dividing line 301 therebetween, i.e., between the electrode 303e and the electrode 303a, of the electrode 303 formed on the devices 302, are set to be constant in the embodiment shown. Similarly, the interval C in the Y direction (the up-down direction in FIG. 5) between the electrodes 303 (303a to 303j) on each device 302 and the interval D between the electrodes adjacent to each other in the Y direction (the up-down direction in FIG. 5) with the planned dividing line 301 therebetween, i.e., between the electrode 303f and the electrode 303a and between the electrode 303j and the electrode 303e, of the electrodes 303 on the devices 302, are set to be constant in the embodiment shown. In regard of the semiconductor wafer 30 thus configured, design data on the numbers of the devices 302 arranged in the rows E1 . . . En and the columns F1 . . . Fn shown in FIG. 4 and on the above-mentioned intervals A, B, C, D are stored in a first storage region 203a of the random access memory (RAM) 203.

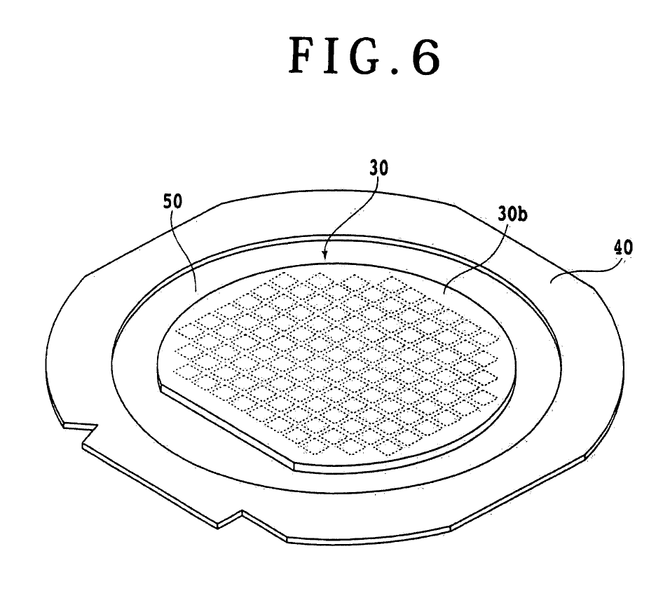

An embodiment of the laser beam machining for forming the machined holes (via holes) in the areas of the electrodes 303 (303a to 303j) of each of the devices 302 formed on the semiconductor wafer 30, conducted by use of the above-described laser beam machining apparatus, will be described below. The surface (face side) 30a of the semiconductor wafer 30 configured as above is adhered to a protective tape 50 composed of a sheet of a synthetic resin such as a polyolefin and attached to an annular frame 40, as shown in FIG. 6. Therefore, the semiconductor wafer 30 is placed with its back side 30b up. The semiconductor 30 supported on the annular frame 40 through the protective tape 50 in this manner is mounted on the chuck table 36 of the laser beam machining apparatus shown in FIG. 1, with the protective tape 50 side in contact with the chuck table 36. Then, the suction means (not shown) is operated so as to hold the semiconductor wafer 30 on the chuck table 36 through the protective tape 50 by suction. In addition, the annular frame 40 is fixed by the clamps 362.

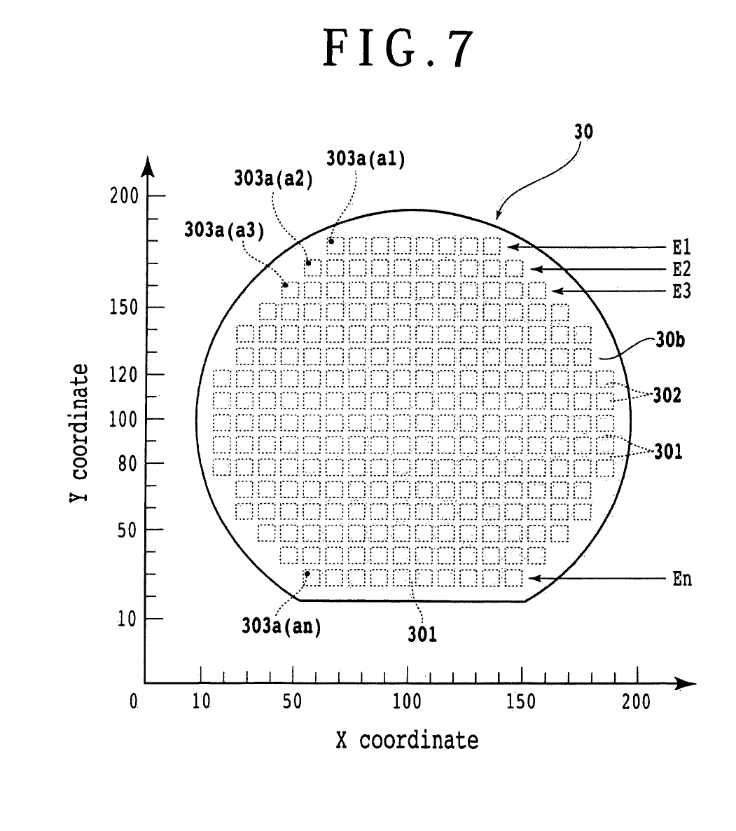

The chuck table 36 with the semiconductor wafer 30 held thereon by suction as above-mentioned is positioned just under the image pickup means 11 by the machining feeding means 37. When the chuck table 36 is positioned just under the image pickup means 11, the semiconductor wafer 30 on the chuck table 36 is in the state of being position in the coordinate position shown in FIG. 7. In this condition, an aligning operation (alignment) is carried out to see that the lattice-like planned dividing lines 301 formed in the semiconductor wafer 30 held on the chuck table 36 are set parallel to the X-axis direction and the Y-axis direction. Specifically, the image of the semiconductor wafer 30 held by the chuck table 36 is picked up by the image pickup means 11, and image processing operations such as pattern matching are carried out, to perform the aligning operation (alignment). In this case, though the surface (face side) 30a provided with the planned dividing lines 301 of the semiconductor wafer 30 is located on the lower side, the planned dividing lines 301 can be imaged in a see-through manner from the back side 301b of the semiconductor wafer 30, since the image pickup means 11 includes the infrared illumination means, the optical system for capturing the infrared rays, the image pickup device (infrared CCD) for outputting an electrical signal corresponding to the infrared rays, etc.

Next, the chuck table 36 is moved so that the device 302 at the leftmost end (in FIG. 7) of the uppermost row E1, of the devices 302 formed on the semiconductor wafer 30, is positioned just under the image pickup means 11. Then, the electrode 303a on the left upper end (in FIG. 7), of the electrodes 303 (303a to 303j) formed on the device 302 is positioned just under the image pickup means 11. When the electrode 303a is detected by the image pickup means 11 in this condition, the coordinates a1 of the electrode 303a are sent to the controller 20 as first machining feed starting position coordinates. Then, the controller 20 stores the coordinates a1 into the random access memory (RAM) 203 as the first machining feed starting position coordinates (machining feed starting position detecting step). In this case, since the image pickup means 11 and the condenser 9 of the laser beam irradiation means 52 are disposed with a predetermined interval therebetween in the X-axis direction, a value obtained by adding the interval between the image pickup means 11 and the condenser 9 to the X coordinate detected is stored as the X coordinate.

When the first machining feed starting position coordinates a1 of the device 302 in the uppermost row E1 in FIG. 7 are thus detected, the chuck table 36 is fed on an indexing basis in the Y-axis direction by the interval of the planned dividing lines 301 and moved in the X-axis direction, whereby the device 302 at the leftmost end in the second uppermost row E2 in FIG. 7 is positioned just under the image pickup means 11. Then, the electrode 303a at the left upper end in FIG. 7, of the electrodes 303 (303a to 303j) formed on the device 302, is positioned just under the image pickup means 11. When the electrode 303a is detected by the image pickup means 11 in this condition, the coordinates a2 of the electrode 303a are sent to the controller 20 as second machining feed starting position coordinates. Then, the controller 20 stores the coordinates a2 into the random access memory (RAM) 203 as the second machining feed starting position coordinates. In this case, since the image pickup means 11 and the condenser 9 of the laser beam irradiation means 52 are disposed with a predetermined interval therebetween in the X-axis direction as above-mentioned, a value obtained by adding the interval between the image pickup means 11 and the condenser 9 to the X coordinate detected is stored as the X coordinate. Thereafter, the controller 20 repeats the indexing feed and the machining feed starting position detecting step until the lowermost row En in FIG. 7 is reached, to thereby detect the machining feed starting position coordinates (a3 to an) of the devices 302 formed in the subsequent rows, and stores the machining feed starting position coordinates (a3 to an) into the random access memory (RAM) 203.

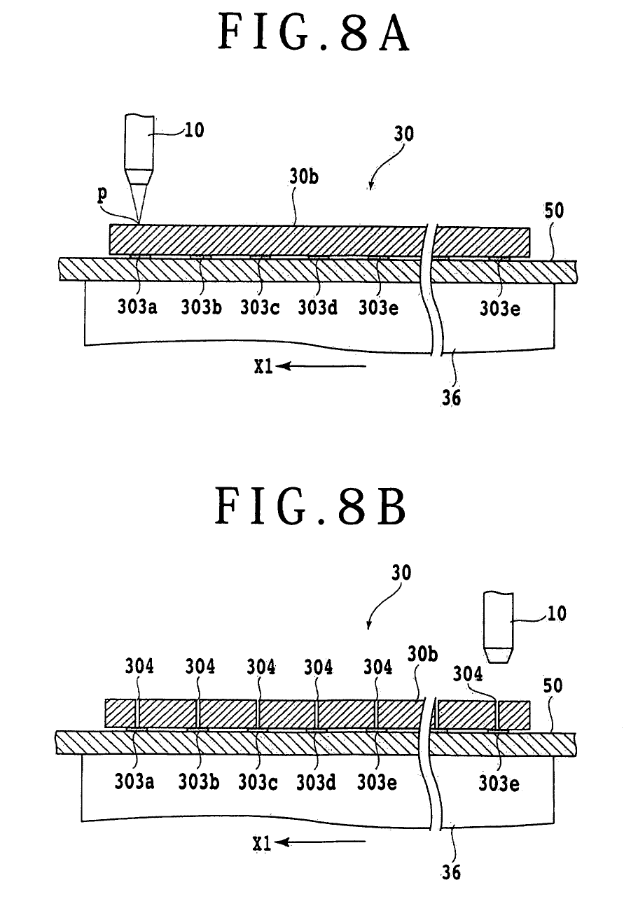

Next, a boring step is carried out to bore laser beam machined holes (via holes) in the areas, of the electrodes 303 (303a to 303j) formed on each of the devices 302, of the semiconductor wafer 30. In carrying out the boring step, the machining feeding means 37 is first operated to move the chuck table 36 so that a wafer part corresponding to the first machining feed starting position coordinates a1 stored in the random access memory (RAM) 203 is positioned just under the condenser 9 of the laser beam irradiation means 52. The condition where the wafer part corresponding to the first machining feed starting position coordinates a1 is thus positioned just under the condenser 9 is shown in FIG. 8A. Starting from the condition shown in FIG. 8A, the controller 20 controls the machining feeding means 37 so as to feed the chuck table 36 on a machining basis at a predetermined moving speed in the direction indicated by arrow X1 in FIG. 8A, and, at the same time, operates the laser beam irradiation means 52 so as to radiate the pulsed laser beam from the condenser 9 for a predetermined time. Incidentally, the convergent point P of the laser beam radiated from the condenser 9 is adjusted to the vicinity of the surface (face side) 30a of the semiconductor wafer 30. In this case, the controller 20 outputs control signals for controlling the deflection angle adjusting means 74 and the output adjusting means 75 of the acousto-optical deflection means 7 to the control means 8, based on a detection signal from the reading head 374b of the machining feed amount detection means 374.

On the other hand, the RF oscillator 72 outputs RF corresponding to control signals from the deflection angle adjusting means 74 and the output adjusting means 75. The power of the RF outputted from the RF oscillator 72 is amplified by the RF amplifier 73, before being applied to the acousto-optical device 71. As a result, the acousto-optical device 71 deflects the pulsed laser beam oscillated from the pulsed laser beam oscillation means 6 within the range from the position indicated by dot-dash line to the position indicated by two-dot chain line in FIG. 2, and adjusts the output of the pulsed laser beam oscillated from the pulsed laser beam oscillation means 6.

An exemplary set of machining conditions in the above-mentioned boring step will be described below.

Light source: LD excitation Q switch Nd: YVO4

Wavelength: 355 nm

Repetition frequency: 10 kHz

Pulse width: 30 ns

Condensed spot diameter: φ 15 μm

Machining feed rate: 100 mm/second

When the boring step is carried out under such machining conditions, the laser machined hole can be formed in the silicon wafer, with a depth of about 5 μm per pulse of the pulsed laser beam. Therefore, in order that a machined hole reaching the electrode 303 is formed in the silicon wafer having a thickness of 50 μm, it is necessary to irradiate the work with 10 pulses of the pulsed laser beam. Accordingly, the part, corresponding to the first machining feed starting position coordinates a1, of the semiconductor wafer 30 held on the chuck table 36 moved at a machining feed rate of 100 mm/second is irradiated with 10 pulses of the pulsed laser beam under the above-mentioned machining conditions, whereby the machined hole reaching the electrode 303 can be formed.

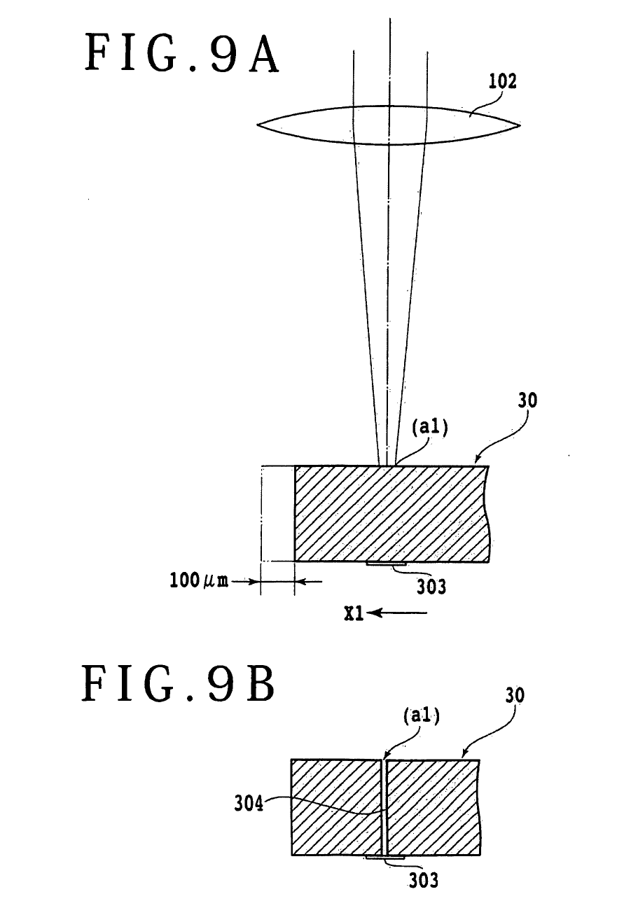

Here, a method for irradiating the part, corresponding to the first machining feed starting position coordinates a1, of the semiconductor wafer 30 with 10 pulses of the pulsed laser beam while the semiconductor wafer 30 is moved at the machining feed rate of 100 mm/second will be described, referring to FIG. 9A. Under the above-mentioned machining conditions, the repetition frequency of the pulsed laser beam is 10 kHz, so that the work is irradiated with 10,000 pulses in one second (in other words, one pulse corresponds to 100,000 ns). Therefore, the time taken to irradiate the work with 10 pulses of the pulsed laser beam is 1/1,000 second. On the other hand, the semiconductor wafer 30 moved in the direction of arrow X1 at the machining feed rate of 100 mm/second is moved by a distance of 100 μm in 1/1,000 second. Therefore, it suffices that the laser beam irradiation means 52 is operated for 1/1,000 second while the semiconductor wafer 30 is moved by 100 μm, and, during this period, a first driving pulse signal DS1 and a second driving pulse signal DS2 applied respectively to the deflection angle adjusting means 74 and the output adjusting means 75 of the acousto-optical deflection means 7 are controlled so as to position the divergent point of the pulsed laser beam to the wafer part corresponding to the first machining feed starting position coordinates a1.

More specifically, the boring operation can be carried out by a method in which, based on the detection signal from the reading head 374b of the machining feed amount detection means 374 which is sent from the controller 20, the control means 8 controls the first driving pulse signal DS1 and the second driving pulse signal DS2 of voltage applied respectively to the deflection angle adjusting means 74 and the output adjusting means 75 of the acousto-optical deflection means 7 for 430 ns, thereby controlling the frequency and amplitude of the RF power impressed on the acousto-optical device 71 of the acousto-optical deflection means 7. As a result, the wafer part corresponding to the first machining feed starting position coordinates a1 can be irradiated with 10 pulses of the pulsed laser beam, even in the condition where the semiconductor wafer 30 is being moved in the machining feed direction X1. Therefore, as shown in FIG. 9B, a laser beam machined hole 304 reaching the electrode 303 is formed in the semiconductor wafer 30 at the position corresponding to the first machining feed starting position coordinates a1. After the wafer part corresponding to the first machining feed starting position coordinates a1 is irradiated with 10 pulses of the pulsed laser beam, the controller 20 controls the control means 8 so as to output a driving pulse signal (DS) for applying a voltage of 0 V to the deflection angle adjusting means 74 of the acousto-optical deflection means 7 for 430 ns each time one pulse of the laser beam is outputted. As a result, RF at a frequency corresponding to 0 V is impressed on the acousto-optical device 71, and the pulsed laser beam LB oscillated from the pulsed laser beam oscillation means 6 is guided to the laser beam absorbing means 77 as indicated by broken line in FIG. 2.

The time for which the acousto-optical deflection means 7 is to be driven in this manner is 0.43% based on the irradiation time of the pulsed laser beam LB, as above-mentioned. Therefore, the time for which the RF is applied to the acousto-optical device 71 is extremely short, as compared with the irradiation time of the pulsed laser beam LB, so that thermal strain generated in the acousto-optical device 71 is suppressed.

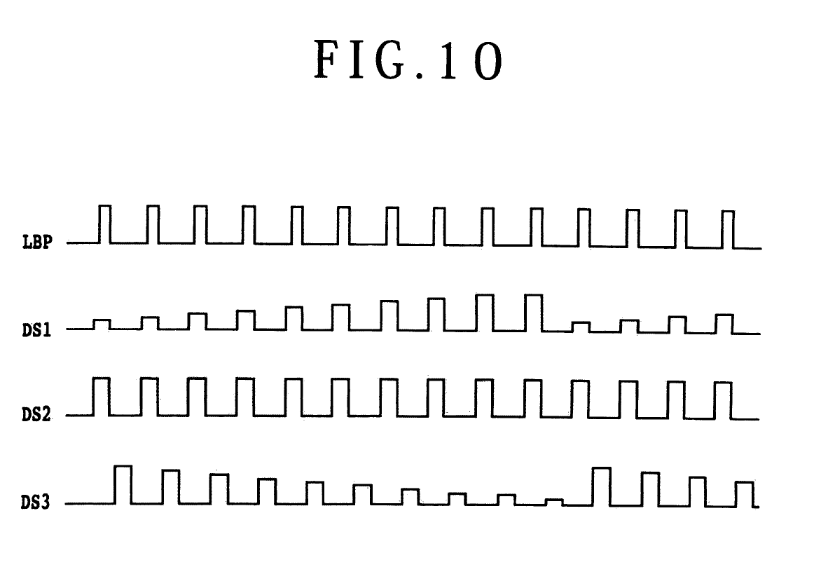

However, as a result of experiments conducted by the present inventors, it has been found out that notwithstanding the time for which the RF is impressed on the acousto-optical device 71 is extremely short as compared with the irradiation time of the pulsed laser beam LB as above-mentioned, the temperature of the acousto-optical device 71 would be somewhat varied to make it impossible to maintain the function of the acousto-optical device 71 at stable accuracy, if the time interval until the next RF application is non-uniform or the output of the RF is uneven. In the present invention, a correction pulse signal DS3 is outputted to the RF output correction means 76, between the driving pulses composing of the first driving pulse signal DS1 and the second driving pulse signal DS2 which are applied respectively to the deflection angle adjusting means 74 and the output adjusting means 75, namely, during when the pulsed laser beam LB is not oscillated. Here, the irradiation timing LBP of the pulsed laser beam LB, the first driving pulse signal DS1, the second driving pulse signal DS2 and the correction pulse signal DS3 will be described, based on a control map shown in FIG. 10.

In FIG. 10, the heights of the pulse signals in the first driving pulse signal DS1, the second driving pulse signal DS2 and the correction pulse signal DS3 represent the heights of voltage. In the embodiment shown in FIG. 10, the voltage of the 10 pulses of the first driving pulse signal DS1 applied to the deflection angle adjusting means 74 is gradually elevated, whereas the voltage of the 10 pulses of the second driving pulse signal DS2 applied to the output adjusting means 75 is constant. On the other hand, the correction pulse signal DS3 applied to the RF output correction means 76 is outputted between the driving pulses composing of the first driving pulse signal DS1 and the second driving pulse signal DS2, namely, during when the pulsed laser beam LB is not oscillated. The voltage of the correction pulse signal DS3 is set, for example, so that sum of the voltage of the first driving pulse signal DS1 and the voltage of the second driving pulse signal DS2 and the voltage of the correction pulse signal DS3 will be constant. Therefore, the RF power applied to the acousto-optical device 71 is constant over the period from the time of oscillation of the pulsed laser beam LB until the next time of oscillation of the pulsed laser beam LB, so that the acousto-optical device 71 is maintained in a predetermined temperature range, and stable accuracy is maintained.

On the other hand, the controller 20 is supplied with the detection signals from the reading head 37 of the machining feed amount detection means 374, and counts the detection signals by the counter 204. When the count obtained by the counter 204 has reached a value corresponding to the interval A in the X-axis direction in FIG. 5, the controller 20 effects the above-mentioned boring step by controlling the laser beam irradiation means 52. Thereafter, also, when the count obtained by the counter 204 has reached the interval B in the X-axis direction in FIG. 5, the controller 20 carries out a control by which the pulsed laser beam LB oscillated from the pulsed laser beam oscillation means 6 is guided to the laser beam absorbing means 77 as indicated by broken line in FIG. 2. More specifically, the controller 20 outputs a control signal to the control means 8 so as to output the first driving pulse signal DS1 for applying a voltage of 0 V to the deflection angle adjusting means 74 of the acousto-optical deflection means 7. As a result, RF at a frequency corresponding to 0 V is applied to the acousto-optical device 71, whereby the pulsed laser beam LB oscillated from the pulsed laser beam oscillation means 6 is guided to the laser beam absorbing means 77 as indicated by broken line in FIG. 2, so that the semiconductor wafer 30 is not irradiated with the laser beam. In this instance, a second driving pulse signal DS 2 for applying a voltage of 0 V is also outputted to the output adjusting means 75 of the acousto-optical deflection means 7. Therefore, RF with an amplitude corresponding to 0 V is applied to the acousto-optical device 71.

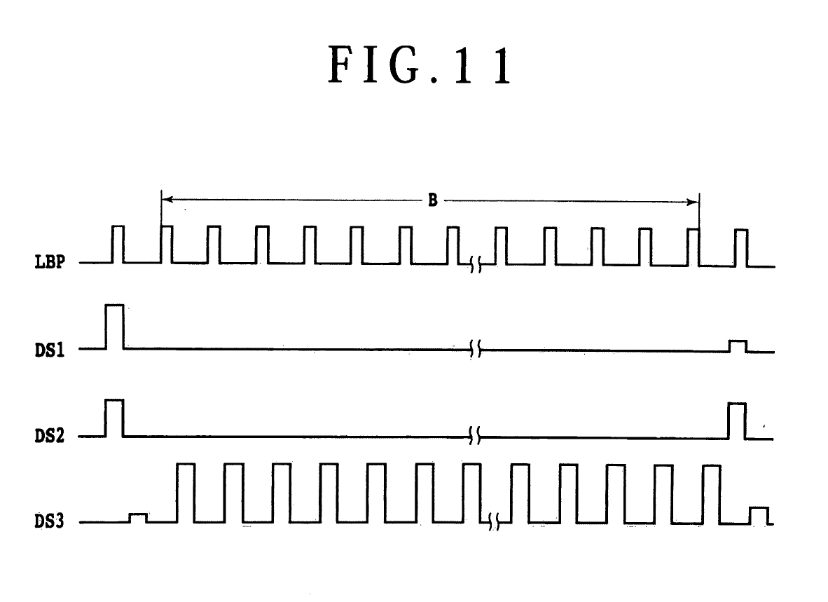

Thus, when the energy of the RF applied to the acousto-optical device 71 becomes zero (0), the temperature of the acousto-optical device 71 is lowered, as above-mentioned, and the function of the acousto-optical device 71 cannot be maintained at stable accuracy. To cope with this problem, in the region of the above-mentioned interval B, the correction pulse signal DS3 is outputted to the RF output correction means 76 on the basis of the control map shown in FIG. 11, between the driving pulses composing of the first driving pulse signal DS1 and the second driving pulse signal DS2 applied respectively to the deflection angle adjusting means 74 and the output adjusting means 75, namely, during when the pulsed laser beam LB is not oscillated. In the region of the interval B, the voltages of the first driving pulse signal DS1 and the second driving pulse signal DS2 applied respectively to the deflection angle adjusting means 74 and the output adjusting means 75 of the acousto-optical deflection means 7 are 0 V, as above-mentioned. In view of this, the voltage of the correction pulse signal DS3 is set, for example, so that the sum of the voltage (0 V) of the first driving pulse signal DS1 and the voltage (0 V) of the second driving pulse signal DS2 and the voltage of the correction pulse signal DS3 will be constant. Therefore, the RF power applied to the acousto-optical device 71 is constant over the period from the time of oscillation of the pulsed laser beam LB until the next time of oscillation of the pulsed laser beam, so that the acousto-optical device 71 is maintained in a predetermined temperature range, and stable accuracy of its function is maintained.

After the boring step is carried out based on the control maps shown in FIGS. 10 and 11 and the boring step is carried out at the position of the electrode 303e at the rightmost end (in FIG. 7) of the electrodes 303 formed on the device 302 at the rightmost end in the row E1 of the semiconductor wafer 30 as shown in FIG. 8B, the operation of the machining feeding means 37 is stopped, whereby the movement of the chuck table 36 is stopped. As a result, laser beam machined holes 304 are formed in the semiconductor wafer 30 in areas of the electrodes 303 (not shown) as shown in FIG. 8B.

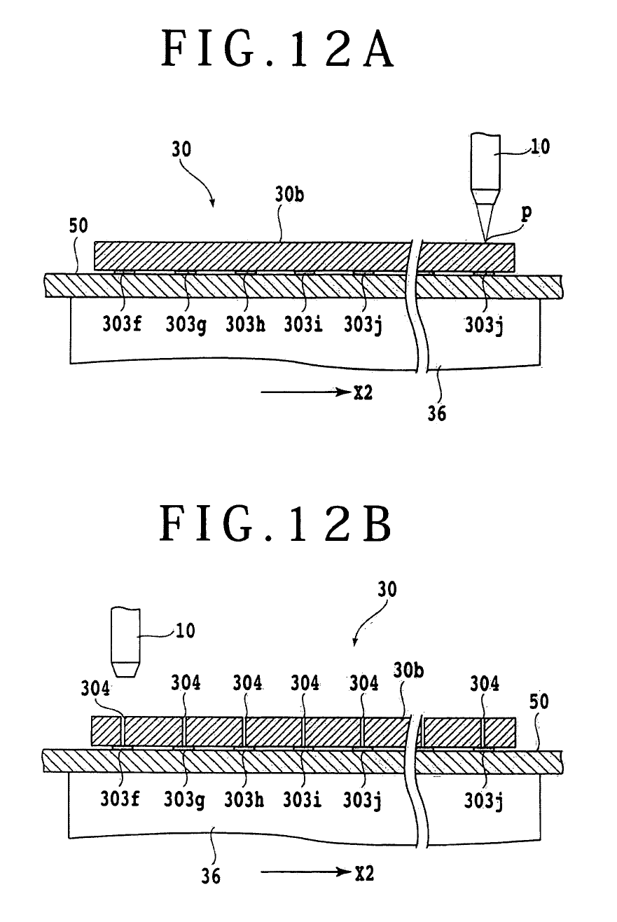

Next, the controller 20 controls the first indexing feeding means 38 so as to feed the condenser 9 of the laser beam irradiation means 52 on an indexing basis in the direction orthogonal to the sheet surface of FIG. 8B. On the other hand, the controller 20 is supplied with detection signals from the reading head 384b of the indexing feed amount detection means 384, and counts the detection signals by the counter 204. When the count obtained by the counter 204 has reached a value corresponding to the interval C in the Y-axis direction in FIG. 5 of the electrodes 303, the operation of the first indexing feeding means 38 is stopped, whereby the indexing feed of the condenser 9 of the laser beam irradiation means 52 is stopped. As a result, the condenser 9 is positioned just above the electrode 303j opposed to the electrode 303e (see FIG. 5). This condition is shown in FIG. 12A.

In the condition shown in FIG. 12A, the controller 20 controls the machining feeding means 37 so as to feed the chuck table 36 on a machining basis at a predetermined moving velocity in the direction indicated by arrow X2 in FIG. 12A, and, simultaneously, operates the laser beam irradiation means 52 to thereby carry out the above-mentioned boring step based on the control maps shown in FIGS. 10 and 11. Then, the controller 20 counts, by the counter 204, the detection signals from the reading head 374b of the machining feed amount detection means 374, as above-mentioned. Each time the count thus obtained has reached the interval A or B, in the X-axis direction in FIG. 5, of the electrodes 303, the controller 20 operates the laser beam irradiation means 52 to thereby perform the boring step. After the boring step is carried out at the position of the electrode 303f formed on the device 302 at the leftmost end in the row El on the semiconductor wafer 30 as shown in FIG. 12B, the operation of the machining feeding means 37 is stopped, whereby the movement of the chuck table 36 is stopped. As a result, the laser beam machined holes 304 are formed in the semiconductor wafer 30 in the areas of the electrodes 303 (not shown) as shown in FIG. 12B.

After the laser beam machined holes 304 are formed in the semiconductor wafer 30 in the areas of the electrodes 303 formed on the devices 302 in the row E1 as above-mentioned, the controller 20 operates the machining feeding means 37 and the first indexing feeding means 38 so that the part, corresponding to the second machining feed starting position coordinates a2 stored in the random access memory (RAM) 203, of the electrodes 303 formed on the devices 302 in the row E2 on the semiconductor wafer 30 is positioned just under the condenser 9 of the laser beam irradiation means 52. Then, the controller 20 controls the laser beam irradiation means 52, the machining feeding means 37 and the first indexing feeding means 38 so as to perform the boring step in the areas of the electrodes 303 formed on the devices 302 in the row E2 on the semiconductor wafer 30. Thereafter, the boring step is carried out also in the areas of the electrodes 303 formed on the devices 302 in the rows E3 to En on the semiconductor wafer 30, based on the control maps shown in FIGS. 10 and 11. As a result, the laser beam machined holes 304 are formed in the areas of all the electrodes 303 formed on the devices 302 on the semiconductor wafer 30.

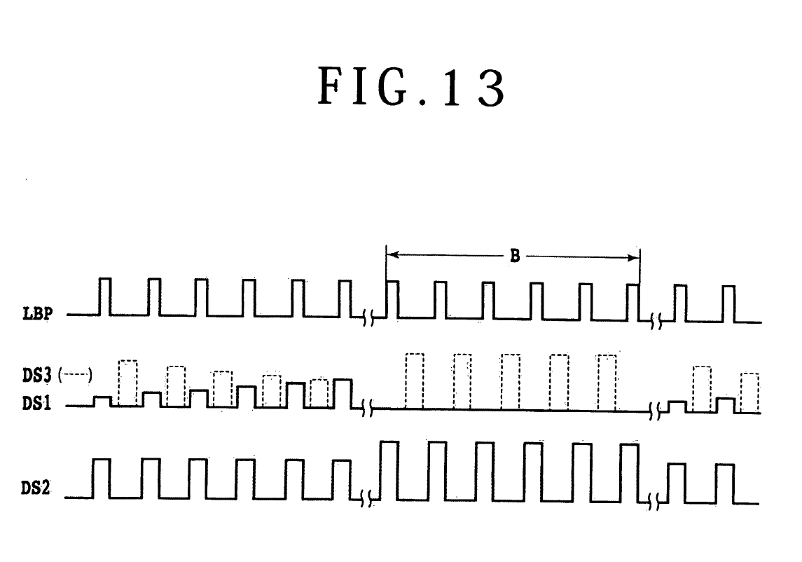

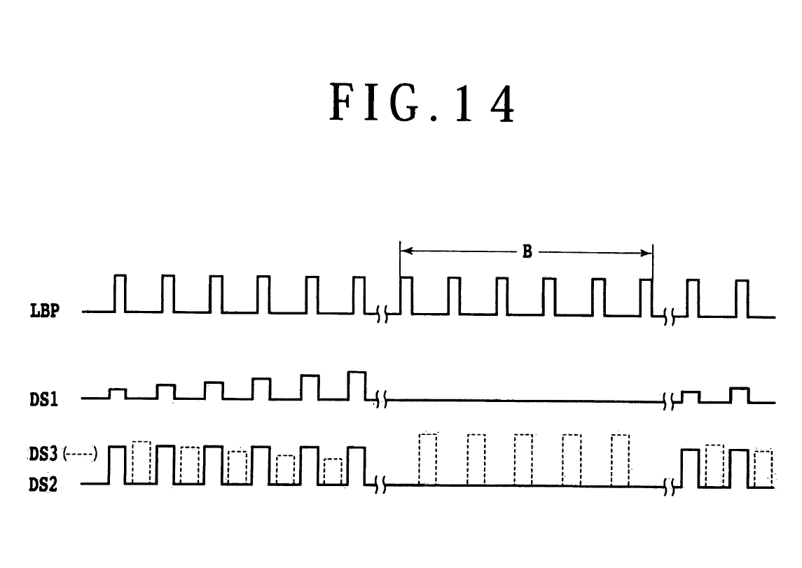

Now, other embodiments of the correction pulse signal DS3 will be described below, based on control maps shown in FIGS. 13 and 14. In the embodiment shown in FIG. 13, the correction pulse signal DS3 is produced in combination with the first driving signal DS1 as indicated by broken lines, and the first driving pulse signal DS1 and the correction pulse signal DS3 are outputted to the deflection angle adjusting means 74 of the acousto-optical deflection means 7. In the embodiment shown in FIG. 14, the correction pulse signal DS3 is produced in combination with the second driving pulse signal DS2 as indicated by broken lines, and the second driving pulse signal DS2 and the correction pulse signal DS3 are outputted to the output adjusting means 75 of the acousto-optical deflection means 7.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser beam irradiation apparatus comprising:
laser beam oscillation means including a pulsed laser beam oscillator for oscillating a pulsed laser beam, and repetition frequency setting means for setting a repetition frequency of said pulsed laser beam oscillated from said pulsed laser beam oscillator;
acousto-optical deflection means including an acousto-optical device for deflecting said pulsed laser beam oscillated from said laser beam oscillation means, an RF oscillator for applying RF to said acousto-optical device, deflection angle adjusting means for adjusting the frequency of said RF outputted from said RF oscillator, and output adjusting means for adjusting the amplitude of said RF outputted from said RF oscillator;
control means for controlling said acousto-optical deflection means and said output adjusting means; and
a condenser for condensing the laser beam deflected by said acousto-optical deflection means,
wherein said control means, based on a repetition frequency setting signal from said repetition frequency setting means, outputs to said deflection angle adjusting means a first driving pulse signal with a predetermined time width containing the pulse width of said pulsed laser beam oscillated by said pulsed laser beam oscillator, outputs a second driving pulse signal to said output adjusting means, and outputs to said RF oscillator a correction pulse signal between the driving pulses comprised of said first driving pulse signal and said second driving pulse signal.

2. The laser beam irradiation apparatus as set forth in claim 1, wherein said control means outputs said correction pulse signal to said deflection angle adjusting means.

3. The laser beam irradiation apparatus as set forth in claim 1, wherein said control means outputs said correction pulse signal to said output adjusting means.

4. The laser beam irradiation apparatus as set forth in claim 1, wherein said acousto-optical deflection means has RF output correction means for adjusting the RF output generated by said RF oscillator, and said control means outputs said correction pulse signal to said RF output correction means.

5. The laser beam irradiation apparatus as set forth in claim 1, wherein said control means has a control map setting voltages of said first driving pulse signal and said second driving pulse signal and said correction pulse signal.

6. A laser beam machining apparatus comprising a chuck table for holding a work, laser beam irradiation means for irradiating said work held by said chuck table with a laser beam, machining feeding means for relatively moving said chuck table and said laser beam irradiation means in a machining feed direction, and indexing means for relatively moving said chuck table and said laser beam irradiation means in an indexing direction orthogonal to said machining feed direction,
wherein said laser beam irradiation means includes the laser beam irradiation apparatus as set forth in claim 1.
